(19) United States
(12) Patent Application Publication
(10) Pub. No.: US 2003/0030613 A1
(43) Pub. Date: Feb. 13, 2003

(54) Method and device for driving a liquid crystal panel

(75) Inventor: Gee Sung Chae, Inchcon-shi (KR)

Correspondence Address: MORGAN LEWIS & BOCKIUS LLP, 1111 PENNSYLVANIA AVENUE NW, WASHINGTON, DC, 20004, US

(73) Assignee: LG. Philips LCD Co., Ltd.

(21) Appl. No.: 10/184,064

(22) Filed: Jun. 28, 2002

(30) Foreign Application Priority Data
Aug. 10, 2001 (KR) P01-048220

(51) Int. Cl. G09G 3/36

(52) U.S. Cl. 345/89

(57) ABSTRACT

A method and device for driving a liquid crystal panel to display at least two pictures having different resolutions from each other. The method and device discriminate regions of images having different resolution from each other in an image signal to be applied to the liquid crystal panel. In the next. Also, the method and device adjust adjusting a brightness to be different difference in accordance with the images of the different resolutions.

This application claims the benefit of Korean Patent Application No. P01-048220, filed in the Republic of Korea on Aug. 10, 2001, which is hereby incorporated by reference.

### BACKGROUND OF THE INVENTION

1. Field of the Invention

The present invention relates to a method and device for driving a liquid crystal panel, and more particularly, to a liquid crystal panel drive method and device capable of minimizing an eye strain of a user when images are displayed having respectively different resolutions on a screen.

2. Discussion of the Related Art

Generally, a liquid crystal display device has an inherent resolution corresponding to the number of integrated pixels, and has a higher resolution as its dimension becomes larger. In order to obtain a high quality picture, manufacturers of liquid crystal display devices increase a pixel integration ratio of a liquid crystal panel as compared to other liquid crystal display devices having same dimension to obtain a higher resolution than the other liquid crystal display devices.

The standards of image signals and control signals under the circumstances of a personal computer, etc. including the liquid crystal display device having the resolution were set by the Video Electronics Standard Association (VESA) on February, 1989.

The typical standards of displays, which are commercially available in the current display industry, include DOS Mode(640×350, 640×400, 720×400), VGA(640×400), SVGA(800×600), XGA(1024×768), SXGA(1280×1024), UXGA(1600×1200) Modes, for example.

The liquid crystal display device has its resolution fixed by the number of arranged pixels and requires the image signals corresponding to the resolution of the liquid crystal panel and the control signals from a driving system. Accordingly, the driving system converts the image signals and the control signals corresponding to various display standards into image signals and controls signals complying with resolution and a display standard of the liquid crystal display device using a scaler chip and the like to apply the same to the liquid crystal display device.

FIG. 1 is a block diagram schematically showing a conventional liquid crystal display device. As shown in this drawing, the conventional liquid crystal display device includes a data driver 18 for supplying a data signal to a liquid crystal panel 22, a gate driver 20 for supplying a scanning signal to the liquid crystal panel 22, and a timing controller 12 for applying data and control signals to the data driver 18 and applying control signals to the gate driver 20. The liquid crystal display device further includes an interface portion 10 for applying a data and control signal to the timing controller 12, and a voltage converter 14 for supplying a gate high voltage Vgh to the gate driver 20 and respectively supplying a common voltage Vcom to the data driver 18, the gate driver 20 and the liquid crystal panel 22.

The interface portion 10 receives data (RGB data) and control signals (e.g., an input clock, a horizontal synchronizing signal, a vertical synchronizing signal and a data enable signal) from a driving system, such as a personal computer or the like, and applies these signals to the timing controller 12. A low voltage differential signal (LVDS) interface and a transistor logic (TTL) interface are mainly used for transmitting a data and control signal to the driving system. The two interfaces are integrated into a single chip along with the timing controller 12 by collecting each function of them.

The timing controller 12 receives control signals input via the interface portion 10 and transfers the control signals to drive the data driver 18 consisting of a plurality of drive integrated circuits (IC's) (not shown) and the gate driver 20 consisting of a plurality of gate drive IC's (not shown). Also, the timing controller 12 transfers data inputted from the interface part 10 to the data driver 18.

The data driver 18 selects reference voltages in accordance with the input data in response to the control signals from the timing controller 12 to convert the control signals into analog image signals and apply the converted analog signals to the liquid crystal panel 22.

The gate driver 20 makes on/off control, one line by one line, of gate terminals of thin film transistors (TFT's) arranged on the liquid crystal panel 22 in response to the control signals inputted from the timing controller 12. Also, the gate driver 20 controls the analog image signals from the data driver 18 to be applied to each pixel connected to each TFT.

The voltage converter 14 supplies a gate high voltage Vgh, which is used to drive the TFTs on the liquid crystal panel 22, to the gate driver 20. Also, the voltage converter 14 generates a common voltage Vcom as a common electrode on the liquid crystal panel 22.

The liquid crystal panel 22 is conventionally driven by an operating system such as a Windows operating system or the like. The Windows operating system can be set up to represent the UXGA Mode of data on the liquid crystal panel 22. The Windows operating system controls various application programs to operate. A user can use a word-processor to edit a document (a record, a note, or the like) by setting up the various application programs. Furthermore, the document can include a graph and/or a photograph which is displayed in a picture-in-picture manner on the liquid crystal panel 22.

FIG. 2 shows two images simultaneously displayed on the liquid crystal panel 22 in a conventional driving method. As shown in this drawing, a picture-in-picture on the liquid crystal panel 22 can be divided into a main picture 11 on the entire area of the liquid crystal panel 22 in the SVGA resolution and a sub picture 21 represented only on a part area of the liquid crystal panel 22 in the UXGA resolution which is higher than the SVGA resolution. Also, the main picture 11 includes text information which can be realized in low resolution, and the sub picture 21 includes graph and photograph information which has high resolution. The main picture 11 and the sub picture 21 vary along with a data voltage, which is applied to the liquid crystal panel 22, in brightness.

FIG. 3 is a graph illustrating a relationship between the brightness and the data voltage which is applied to the liquid crystal 22. As shown in this drawing, a data signal of the main picture 11 applied to the liquid crystal panel 22 through the data driver 18 is generated in the driving system such that the data signal of the main picture 11 is equal to a data signal of the sub picture 21 in voltage. Therefore, the main picture 11 and the sub picture 21, which are displayed on the liquid crystal panel 22, have the same brightness regardless the resolution of the respective data signals (or the respective pictures 11 and 21).

Since the data voltage of the data signal for realizing the main picture 11 of the SVGA resolution is equal to that of the data signal for implementing the sub picture 21 of the UXGA resolution which is higher than that of the main picture 11, the sub picture 21 including the graph and photograph information and the resolution higher than the main picture 11 is not more definite than the main picture 11. In other words, the main picture 11 of the SVGA resolution is equal to the sub picture 21 of the UXGA resolution in brightness at about 150 nit. Herein, “nit” is an amount of light emitted from a unit dimension within a unit solid angle. For example, a cathode ray tube has a maximum value of 300 nit and an average value of 230 nit.

As described above, since the main picture 11 and the sub pictures 21, which are simultaneously displayed on the liquid crystal panel 22, have the same brightness distribution, the sub picture 21 is lower than the main picture 11 in picture quality. Also, the eyes of the user are usually centralized at the graph and photograph information rather than the text information. For this reason, the eye strain increases.

FIG. 4 shows another two images simultaneously displayed on the liquid crystal panel 22 in the conventional driving method. As shown in this drawing, a picture-in-picture on the liquid crystal panel 22 has resolution different from that of FIG. 3.

As shown in FIG. 4, the picture-in-picture on the liquid crystal panel 22 can be divided into a main picture 30 displayed on the entire area of the liquid crystal panel 22 in the SVGA resolution and a sub picture 40 represented only on a part area of the liquid crystal panel 22 in the XGA resolution which is higher than the SVGA resolution. The main picture 30 includes text information which can be realized in low resolution, and the sub picture 40 includes graph and photograph information which has high resolution. A data signal of the main picture 30 applied to the liquid crystal panel 22 through the data driver 18 is generated in the driving system such that the data signal of the main picture 30 is equal to a data signal of the sub picture 40 in voltage. Therefore, the main picture 30 and the sub picture 40, which are displayed on the liquid crystal panel 22, have the same brightness regardless the resolution of the respective data signals (or the respective pictures 30 and 40).

Since the data voltage of the data signal for realizing the main picture 30 of the SVGA resolution is equal to that of the data signal for implementing the sub picture 40 of the XGA resolution which is higher than that of the main picture 30, the sub picture 40 including the graph and photograph information and the resolution higher than that of the main picture 30 is not more definite than the main picture 30. In other words, the main picture 30 of the SVGA resolution is equal to the sub picture 40 of the XGA resolution in brightness at about 150 nit. Herein, “nit” is an amount of light emitted from a unit dimension within a unit solid angle.

As described above, since the main picture 30 and the sub pictures 40, which are simultaneously displayed on the liquid crystal panel 22, have the same brightness distribution, the sub picture 40 is lower than the main picture 30 in picture quality. Also, the eyes of the user are usually centralized at the graph and photograph information rather than the text information. For this reason, the eye strain increases.

Accordingly, when a picture at a high resolution and a picture at a low resolution are simultaneously displayed on the liquid crystal display, it is necessary that the picture at the high resolution has a higher brightness level than that of the picture at the low resolution.

### SUMMARY OF THE INVENTION

Accordingly, the present invention is directed to a method and device for driving a liquid crystal panel that substantially obviates one or more of the problems due to limitations and disadvantages of the related art.

An object of the present invention is to provide a method and device for driving a liquid crystal panel that minimizes an eye strain of an individual viewing the liquid crystal panel when images displayed on the liquid crystal panel are different in resolution.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In order to achieve these and other advantages, and in accordance with the purpose of the present invention, as embodied and broadly described, the method of driving a liquid crystal panel includes discriminating regions of images having different resolution from each other in an image signal to be applied to the liquid crystal panel, and adjusting a brightness to be different difference in accordance with the images of the different resolutions.

In still another aspect, the device for driving a liquid crystal panel includes a discriminating unit for discriminating regions of images having different resolution from each other in an image signal to be applied to the liquid crystal panel, and an adjusting unit for adjusting a brightness to be different difference in accordance with the images of the different resolutions.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram schematically showing a conventional liquid crystal display device.

FIG. 2 shows two images simultaneously displayed on the liquid crystal panel in a conventional driving method.

FIG. 3 is a graph illustrating a relationship between brightness and a data voltage which is applied to the liquid crystal panel in a convention driving method.

FIG. 4 shows another two images simultaneously displayed on the liquid crystal panel in a conventional driving method.

FIG. 5 shows two images simultaneously displayed on a liquid crystal panel in a method of driving a liquid crystal panel in accordance with the present invention.

FIG. 6 is a graph illustrating a relationship between brightness and a data voltage which is applied to the liquid crystal panel in the method of driving the liquid crystal panel in accordance with the present invention.

FIG. 7 shows another two images simultaneously displayed on the liquid crystal panel in the method of driving the liquid crystal panel in accordance with the present invention.

FIG. 8 is a flow chart illustrating a method of driving a liquid crystal panel of a first embodiment in accordance with the present invention.

FIG. 9 is a flow chart illustrating a method of driving a liquid crystal panel of a second embodiment in accordance with the present invention.

FIG. 10 is a flow chart illustrating a method of driving a liquid crystal panel of a third embodiment in accordance with the present invention.

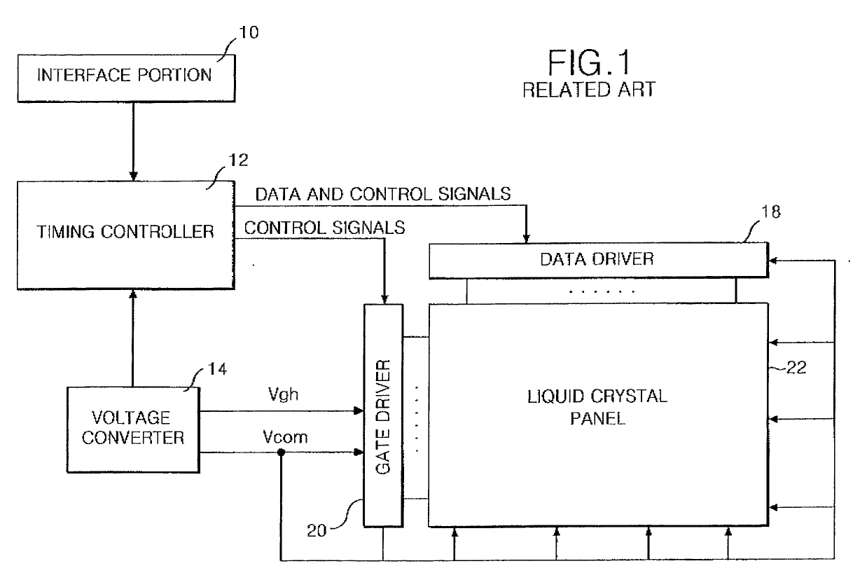

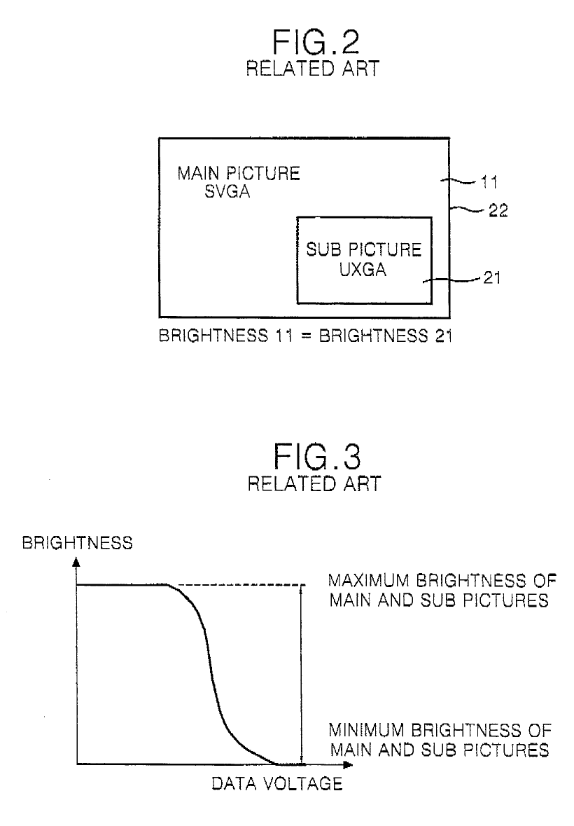

### DETAILED DESCRIPTION OF THE PREFERRED EMBODIMENTS

Reference will now be made in detail to the preferred embodiments of the present invention, examples of which are illustrated in the accompanying drawings. Whenever possible, the same reference numbers will be used throughout the drawings to refer the same or like parts.

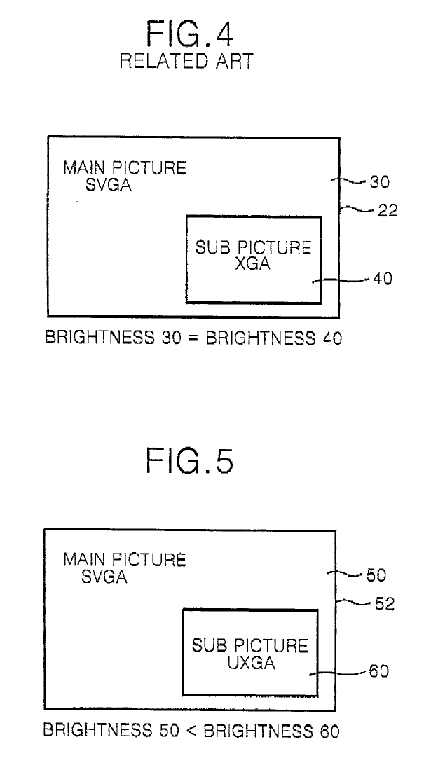

FIG. 5 shows two images simultaneously displayed on a liquid crystal panel 52 in a liquid crystal panel drive method in accordance with the present invention. As shown in this drawing, a picture-in-picture is displayed on the liquid crystal panel 52 according to a first embodiment of the present invention.

The liquid crystal panel 52 is driven, for example, by the Windows operating system. The Windows operating system can be set up to support the UXGA Mode of data on the liquid crystal panel 52. The Windows operating system controls various application programs to operate. The user can use a word-processor to edit a document (a record, a note or the like) by setting up the various application programs. In editing of the document, the document can include a graph and/or a photograph displayed in a picture-in-picture manner on the liquid crystal panel 52.

In FIG. 5, the picture-in-picture on the liquid crystal panel 52 can be divided into a main picture 50 displayed on the entire area of the liquid crystal panel 52 in the SVGA resolution and a sub picture 60 displayed only on a part area of the liquid crystal panel 52 in the UXGA resolution which is higher than the SVGA resolution. The main picture 50 includes text information which can be realized at a low resolution, and the sub picture 60 includes graph and photograph information at a high resolution.

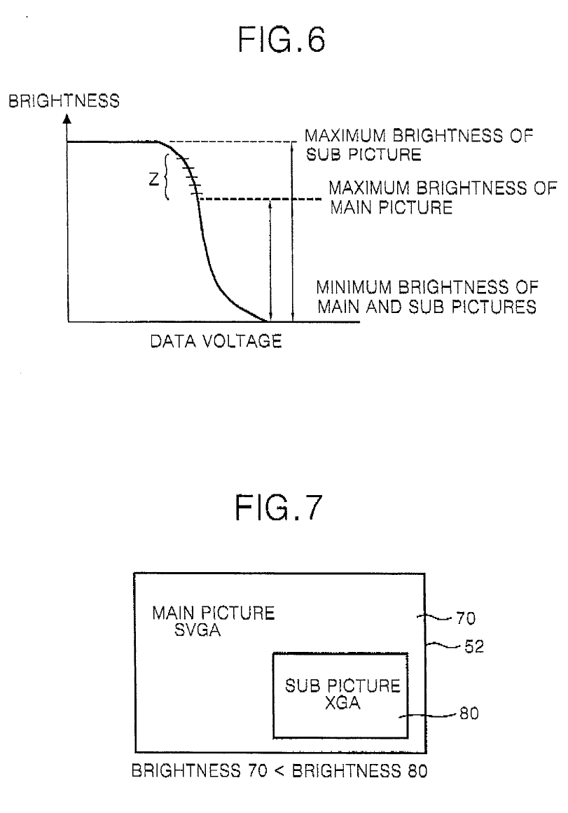

A data signal of the main picture 50 applied to the liquid crystal panel 52 is generated in the driving system such that the data signal of the main picture 50 is different from a data signal of the sub picture 60 in voltage, as shown in FIG. 6. FIG. 6 is a graph illustrating a relationship between a brightness level and a data voltage which is applied to the liquid crystal panel in the method of driving the liquid crystal panel in accordance with the present invention. Accordingly, the main picture 50 and the sub picture 60, which are displayed on the liquid crystal panel 52, differ from each other in their respective brightness levels.

In detail, the driving system applying the data signal to the liquid crystal panel 52 through the interface portion 10, the timing controller 12 and the data driver 18 forces a voltage range (or voltage swing width or voltage distribution) of the data signal to be differentiated in accordance with the resolution of a picture, as shown in FIG. 6. For example, the driving system enables the data voltage corresponding to the brightness of about 0˜200 nit to be applied from the data driver 18 to the liquid crystal panel 52, while the main picture 50 is displayed thereon. When the sub picture 60 is displayed, the driving system forces the data voltage corresponding to the brightness of about 0˜300 nit to be applied from the data driver 18 to the liquid crystal panel 52. The data voltage for the sub picture 60 is selected by a user to have a voltage level among voltage levels Z being higher than that for the main picture 50 as a maximum voltage. Therefore, the brightness level of the sub picture 60 is larger than that of the main picture 50 at a maximum value. As a result, the sub picture 60 becomes brighter than the main picture 50.

In other words, since the sub picture 60 of the UXGA resolution is higher than the main picture 50 of the SVGA resolution by about 100 nit in the brightness, the sub picture 60 is brighter than the main picture 50.

As described above, in a case where a high fine picture and a non-high fine picture are displayed on one screen, the present invention is characterized that the high fine picture is forced to be bright with opposition to the non-high fine picture so that an eye strain of a user can be minimized.

FIG. 7 shows another two images simultaneously displayed on the liquid crystal panel 52 in the method of driving the liquid crystal panel in accordance with the present invention. As shown in this drawing, the picture-in-picture on the liquid crystal panel 52 can be divided into a main picture 70 on the entire area of the liquid crystal panel 52 in the SVGA resolution and a sub picture 80 displayed only on a part area of the liquid crystal panel 52 in the XGA resolution which is higher than the SVGA resolution. The main picture 70 includes text information which can be realized at a low resolution, and the sub picture 80 includes graph and photograph information which has a high resolution. A data signal of the main picture 70 applied to the liquid crystal panel 52 is generated in the driving system such that it is differentiated from a data signal of the sub picture 80 in voltage, as shown in FIG. 6. Accordingly, the main picture 70 and the sub picture 80, which are displayed on the liquid crystal panel 52, have different brightness levels with respect to each other.

In detail, the driving system applying the data signal to the liquid crystal panel 52 through the interface portion 10, the timing controller 12 and the data driver 18 forces a voltage range (voltage swing width, voltage distribution, or the like) of the data signal to be changed in accordance with the resolution of the picture, as shown in FIG. 6. For example, the driving system enables the data voltage corresponding to the brightness of about 0˜200 nit to be applied from the data driver 18 to the liquid crystal panel 52, when the main picture 70 is displayed on the liquid crystal panel 52. When the sub picture 80 is displayed, the driving system forces the data voltage corresponding to the brightness of about 0˜300 nit to be applied from the data driver 18 to the liquid crystal panel 52. The user can select the data voltage for the sub picture 80 to have a voltage level among voltage levels Z being higher than that for the main picture 70 as a maximum voltage. Therefore, the brightness level of the sub picture 80 is larger than that of the main picture 70 in maximum value. As a result, the sub picture 80 becomes brighter than the main picture 70.

In other words, since the sub picture 80 of the XGA resolution is higher than the main picture 70 of the SVGA resolution by about 100 nit in the brightness, the sub picture 80 is brighter than the main picture 70.

As described above, in a case where a high fine picture and a non-high fine picture are displayed on one screen, the present invention is characterized in that the high fine picture is forced to be bright with opposition to the non-high fine picture so that an eye strain of the user can be minimized.

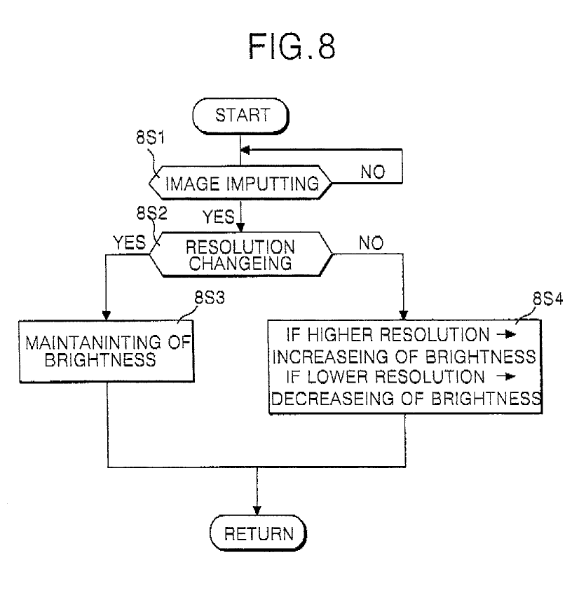

FIG. 8 is a flow chart illustrating step by step a procedure of a method for driving a liquid crystal panel of the first embodiment in accordance with the present invention. The flow chart of FIG. 8 is performed by a CPU (Central Process Unit) built in a personal computer, a notebook computer, or the like.

At Step 8S1, the CPU checks whether an image signal is inputted therein. In other words, the CPU stands by until the image signal is inputted.

At Step 8S2, the CPU determines whether the input image signal is equal to a previous image signal in the resolution. Specifically, when the resolution of the input image signal is equal to that of the previous image signal, the procedure goes to Step 8S3, where the CPU maintains a voltage range for the input image signal in a previous voltage range so that the brightness level of a picture corresponding to the image signal is maintained.

Meanwhile, when the resolution of the input image signal is not equal to that of the previous image signal, the procedure goes to Step 8S4, where the CPU checks whether the resolution of the input image signal is higher or lower than that of the previous image signal. If the resolution of the input image signal is higher than that of the previous image signal, the CPU decreases the voltage range for the image signal by an additional range which is previously established in accordance with the resolution, so that the brightness level of the picture corresponding to the image signal becomes low. When the resolution of the input image signal is lower than that of the previous image signal, the CPU increases the voltage range for the image signal by the additional range so that the brightness level of the picture corresponding to the image signal becomes high.

It is assumed that an image signal having the low resolution belongs to the SVGA Mode and an image signal having the high resolution belongs to the XGA Mode or the UXGA Mode. If the resolution of the image signal is changed from the SVGA Mode to the XGA Mode or the UXGA Mode, the voltage range of the image signal is increased by the additional range so that the picture of the XGA Mode or the UXGA Mode becomes higher than that of the SVGA Mode in the brightness. When the resolution of the image signal is changed from the XGA Mode_or the UXGA Mode to the SVGA Mode, the voltage range of the image signal is decreased by the additional range so that the picture of the SVGA Mode is lower than that of the XGA Mode or the UXGA Mode in the brightness.

As described above, the liquid crystal panel drive method according to the present invention increases the brightness level of the image signal having the high resolution on the basis of the resolution of the input image signal so that the picture corresponding to the image signal having the high resolution is brighter than the picture corresponding to the image signal having the low resolution. As a result, in a case where a high fine picture and a non-high fine picture are displayed on one screen, the present invention is characterized in that the high fine picture becomes bright with opposition to the non-high fine picture so that an eye strain of the user can be minimized.

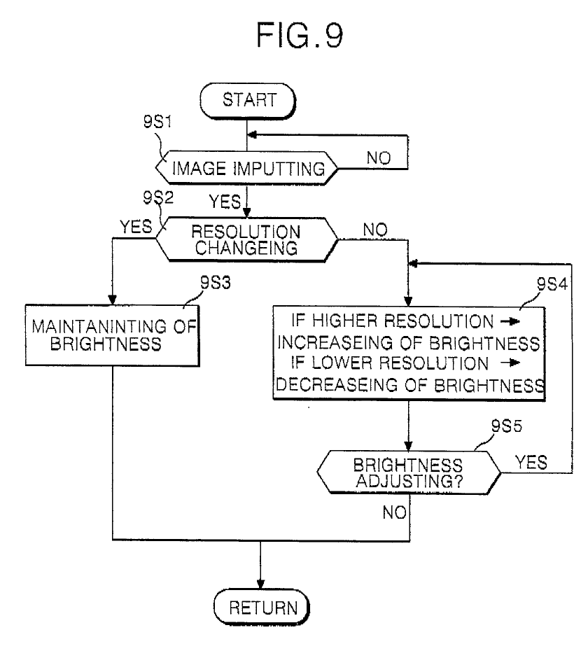

FIG. 9 is a flow chart illustrating step by step a procedure of a method for driving the liquid crystal panel of a second embodiment in accordance with the present invention. The flow chart of FIG. 9 is performed by a CPU built in a personal computer, a notebook computer, or the like.

As Step 9S1, the CPU checks whether an image signal is input therein. In other words, at this step, the CPU stands by until the image signal is received.

As Step 9S2, the CPU determines whether the input image signal is equal to a previous image signal in the resolution. When the resolution of the input image signal is equal to that of the previous image signal, the procedure goes to Step 9S3, where the CPU maintains a voltage range for the input image signal in a previous voltage range so that the brightness level of a picture corresponding to the image signal is maintained.

Meanwhile, when the resolution of the input image signal is not equal to that of the previous image signal, the procedure goes to Step 9S4, where the CPU checks whether the resolution of the input image signal is higher or lower than that of the previous image signal. If the resolution of the input image signal is higher than that of the previous image signal, the CPU decreases the voltage range for the image signal by an additional range which is previously established in accordance with the resolution, so that the brightness level of the picture corresponding to the image signal becomes low. When the resolution of the input image signal is lower than that of the previous image signal, the CPU increases the voltage range for the image signal by the additional range so that the brightness level of the picture corresponding to the image signal becomes high.

It is assumed that an image signal having low resolution belongs to the SVGA Mode and an image signal having high resolution belongs to the XGA Mode or the UXGA Mode. If the resolution of the image signal is changed from the SVGA Mode to the XGA Mode or the UXGA Mode, the voltage range of the image signal is increased by the additional range so that the picture of the XGA Mode or the UXGA Mode becomes higher than that of the SVGA Mode in its brightness level. When the resolution of the image signal is changed from the XGA Mode or the UXGA Mode to the SVGA Mode, the voltage range of the image signal is decreased by the additional range so that the picture of the SVGA Mode becomes lower than that of the XGA Mode or the UXGA Mode in its brightness level.

Finally, at Step 9S5, the CPU checks whether a re-adjustment of a brightness level needs to be performed according to a command of the user. In other words, the CPU confirms whether the user is satisfied with a picture having high resolution which has been adjusted before. If not receiving the command to perform re-adjustment of the brightness level from the user, the CPU maintains the brightness level of the picture which has been adjusted before. If receiving the command to perform re-adjustment of the brightness level from the user, the CPU returns to Step 9S4 so that the voltage range of the image signal is adjusted. At Step 9S5, the brightness level of the picture is re-adjusted repeatedly until the user is satisfied with the brightness level.

A method for driving the liquid crystal panel of the second embodiment in accordance with the present invention increases the brightness level of an image signal having the high resolution in a command of the user on the basis of the resolution of an input image signal so that a picture corresponding to the image signal having the high resolution is brighter than a picture corresponding to an image signal having the low resolution. As a result, an eye strain of the user can be minimized.

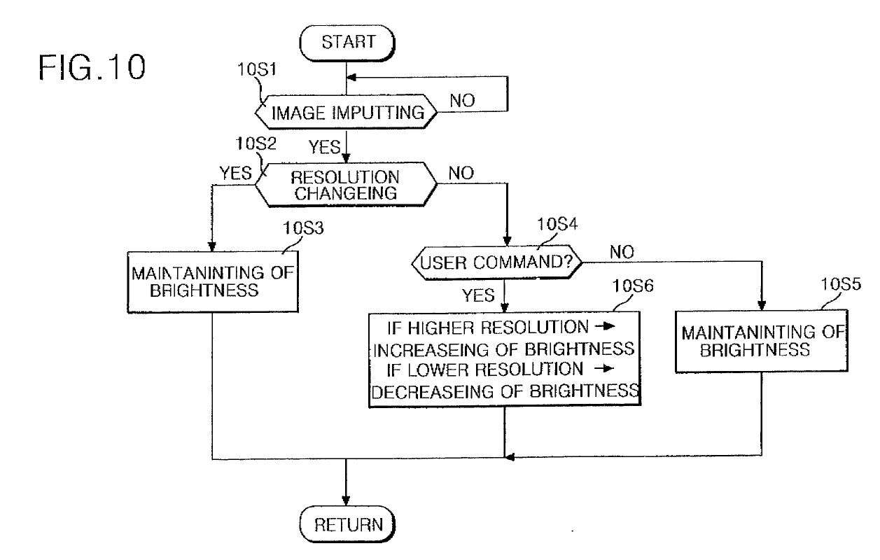

FIG. 10 is a flow chart illustrating step by step a procedure of a method for driving a liquid crystal panel of a third embodiment in accordance with the present invention. The flow chart of FIG. 10 is performed by a CPU (Central Process Unit) built in a personal computer, a notebook computer, and the like.

At Step 10S1, the CPU checks whether an image signal is inputted therein. In other words, at this step, the CPU stands by until the image signal is received.

At Step 10S2, the CPU determines whether the input image signal is equal to a previous image signal in the resolution. When the resolution of the input image signal is equal to that of the previous image signal, the procedure goes to Step 10S3, where the CPU maintains a voltage range for the input image signal in a previous voltage range so that the brightness level of a picture corresponding to the image signal is maintained.

Meanwhile, when the resolution of the input image signal is not equal to that of the previous image signal, the procedure goes to Step 10S4, where the CPU conforms if a command from the user is received. The command from the user is sent to the CPU when user wants to adjust the brightness level of the picture.

If the command from the user is not received, the procedure goes to Step 10S5, where the CPU maintains a voltage range for the input image signal in a previous voltage range so that the brightness level of a picture corresponding to the image signal is maintained. On the other hand, when the command from the user is received, the procedure goes to Step 10S6, where the CPU checks whether the resolution of the input image signal is higher or lower than that of the previous image signal. If the resolution of the input image signal is higher than that of the previous image signal, the CPU decreases the voltage range for the image signal by an additional range which is previously established in accordance with the resolution, so that the brightness level of the picture corresponding to the image signal becomes low. When the resolution of the input image signal is lower than that of the previous image signal, the CPU increases the voltage range for the image signal by the additional range so that the brightness level of the picture corresponding to the image signal becomes high.

A method for driving a liquid crystal panel of the third embodiment in accordance with the present invention increases the brightness level of the image signal having the high resolution in a command of the user on the basis of the resolution of the input image signal so that a picture corresponding to the image signal having the high resolution is brighter than a picture corresponding to an image signal having the low resolution. As a result, an eye strain of the user can be minimized.

As described above, the liquid crystal panel drive method according to the present invention increases the brightness level of an image signal having a high resolution on the basis of the resolution of the input image signal so that a picture corresponding to the image signal of the high resolution is brighter than a picture corresponding to an image signal at a low resolution. As a result, in a case where a high fine picture and a non-high fine picture are displayed on one screen, the present invention is characterized in that the high fine picture is made brighter than the non-high fine picture so that an eye strain of the user can be minimized. Moreover, the method for driving a liquid crystal panel according to the present invention changes the data voltage applied to the liquid crystal panel on the basis of the resolution of a picture (or an image signal), thereby reducing the power consumed by the liquid crystal panel.

It will be apparent to those skilled in the art that various modifications and variation can be made in the method for driving a liquid crystal panel in accordance with the present invention without departing from the spirit or scope of the invention. Thus, it is intended that the present invention cover the modifications and variations of this invention provided they come within the scope of the appended claims and their equivalents.

What is claimed is:

1. A method of driving a liquid crystal panel to display at least two images having different resolutions from each other, comprising:
discriminating regions of images having different resolution from each other in an image signal to be applied to the liquid crystal panel; and
adjusting a brightness to be different difference in accordance with the images of the different resolutions.

2. The method according to claim 1, wherein the adjusting of the brightness allows the image with a high resolution to be high in the brightness.

3. The method according to claim 1, wherein the adjusting of the brightness allows the images of the different resolutions to be differently controlled by an user.

4. The method according to claim 1, wherein the adjusting of the brightness enables an image of high resolution to be larger than an image of low resolution in a voltage range.

5. A device of driving a liquid crystal panel to display at least two images having different resolutions from each other, comprising:
a discriminating unit for discriminating regions of images having different resolution from each other in an image signal to be applied to the liquid crystal panel; and
an adjusting unit for adjusting a brightness to be different difference in accordance with the images of the different resolutions.

6. The device according to claim 5, wherein the adjusting unit allows the image with a high resolution to be high in the brightness.

7. The device according to claim 5, wherein the adjusting unit allows the images of the different resolutions to be differently controlled by an user.

8. The device according to claim 5, wherein the adjusting unit enables an image of high resolution to be larger than an image of low resolution in a voltage range.
